(19) United States
(12) Patent Application Publication
(10) Pub. No.: US 2014/0174490 A1
(43) Pub. Date: Jun. 26, 2014

(54) TAPPED AUXILIARY WINDING DISHWASHER MOTOR

(71) Applicant: NIDEC MOTOR CORPORATION, St. Louis, MO (US)

(72) Inventors: Keith I. Hoemann, Fenton, MO (US); Jason A. Richter, Glen Carbon, IL (US)

(73) Assignee: Nidec Motor Corporation, St. Louis, MO (US)

(21) Appl. No.: 13/725,292

(22) Filed: Dec. 21, 2012

(51) Int. Cl. H02K 3/28

(52) U.S. Cl. CPC H02K 3/28
USPC 134/58 D; 310/210

(57) ABSTRACT

A motor assembly comprises an electric motor and a motor controller. The motor includes a stator; a rotor; a main winding; a first auxiliary winding; a second auxiliary winding; a capacitor; a first tap point between the main winding and the first auxiliary winding; and a second tap point between the first and second auxiliary windings. The motor controller may energize the first tap point so that the first and second auxiliary windings are in series with the capacitor and the first and second auxiliary windings and the capacitor are in parallel with the main winding to provide a relatively higher motor speed or may energize the second tap point so that only the second auxiliary winding is in series with the capacitor and the second auxiliary winding and the capacitor are in parallel with the main winding to provide a relatively lower motor speed.

### BACKGROUND

Most older dishwashers are powered by single phase, single speed induction motors. Such motors are inexpensive, but they are relatively loud, have no speed control, and have low starting torque. Some variable speed operation can be obtained from those motors by using triacs and tachometers to adjust their voltage, but the triacs and tachometers increase the cost and complexity of the motors.

Many newer dishwashers have three phase, brushless permanent magnet (BPM) motors. Such motors are quieter than single phase motors and provide variable speed operation that allows for multiple water pressures and spray patterns to enhance dishwasher operation. However, BPM motors are relatively expensive and therefore not cost-effective for many residential type dishwashers. Some dishwashers sold primarily in Europe have T-connected motors that provide two speeds, but such a motor configuration also has limitations.

The above section provides background information related to the present disclosure which is not necessarily prior art.

### SUMMARY

Embodiments of the present invention solve the above described problems by providing a dishwasher motor that can be operated in more than one speed, is efficient and quiet, yet is still relatively inexpensive.

A motor assembly constructed in accordance with an embodiment of the present invention is specifically configured for use in a dishwasher and broadly comprises an electric motor and a motor controller. The motor is a permanent split capacitor (PSC) induction motor and includes a stator; a rotor rotatably positioned within the stator; a main winding coupled with the stator; a first auxiliary winding coupled with the stator; a second auxiliary winding coupled with the stator; and a capacitor in series with the first and second auxiliary windings. In accordance with one aspect of the present invention, the motor also includes a first tap point between the main winding and the first auxiliary winding and a second tap point between the first and second auxiliary windings.

The motor controller powers and controls the motor and is programmed or otherwise configured to perform at least some of the methods and functions described herein. In one embodiment, the motor controller is programmed or configured to selectively energize the first and second taps to provide multi-speed operation of the motor. Specifically, when a relatively higher motor speed is desired, the motor controller may energize the first tap point so that the first and second auxiliary windings are in series with the capacitor and the first and second auxiliary windings and the capacitor are in parallel with the main winding. When a relatively lower motor speed is desired, the motor controller may energize the second tap point so that only the second auxiliary winding is in series with the capacitor and the second auxiliary winding and the capacitor are in parallel with the main winding.

The motor controller essentially selectively energizes the auxiliary windings to vary the effective turn ratio between the auxiliary windings and the main winding. At higher speed modes of operation, the effective turn ratio is maximized, while at lower speeds, the first auxiliary winding is effectively removed from the total auxiliary winding and placed in series with the main winding, thus reducing the effective turn ratio and the speed of the motor.

The motor assembly of the present invention provides many advantages over conventional dishwasher motors. For example, the motor assembly provides a cost-effective way to obtain multi-speed dishwasher operation to enable multiple spray patterns and other operating modes. The motor assembly also provides quieter and more efficient operation when in its low speed and higher speed and torque when needed for unclogging filters, breaking seals, unclogging impellers, etc.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### DRAWINGS

Embodiments of the present invention are described in detail below with reference to the attached drawing figures, wherein:

FIG. 1 is a block diagram of a motor assembly constructed in accordance with an embodiment of the invention.

FIG. 2 is a schematic representation of the stator and rotor of the motor in the motor assembly of FIG. 1.

FIG. 3 is a circuit diagram depicting the motor windings of the stator and portions of the motor controller.

FIG. 4 is a schematic diagram of an exemplary dishwasher in which the motor assembly of the present invention may be used.

FIG. 5 is a circuit diagram depicting the windings and other components of another embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Turning now to the drawing figures, and initially FIG. 1, a motor assembly 10 constructed in accordance with embodiments of the invention is illustrated. The motor assembly 10 is configured for use with a dishwasher as described in more detail below and broadly includes an electric motor 12 and a motor controller 14. The motor assembly 10 may also include or be coupled with other systems or components not relevant to the present invention.

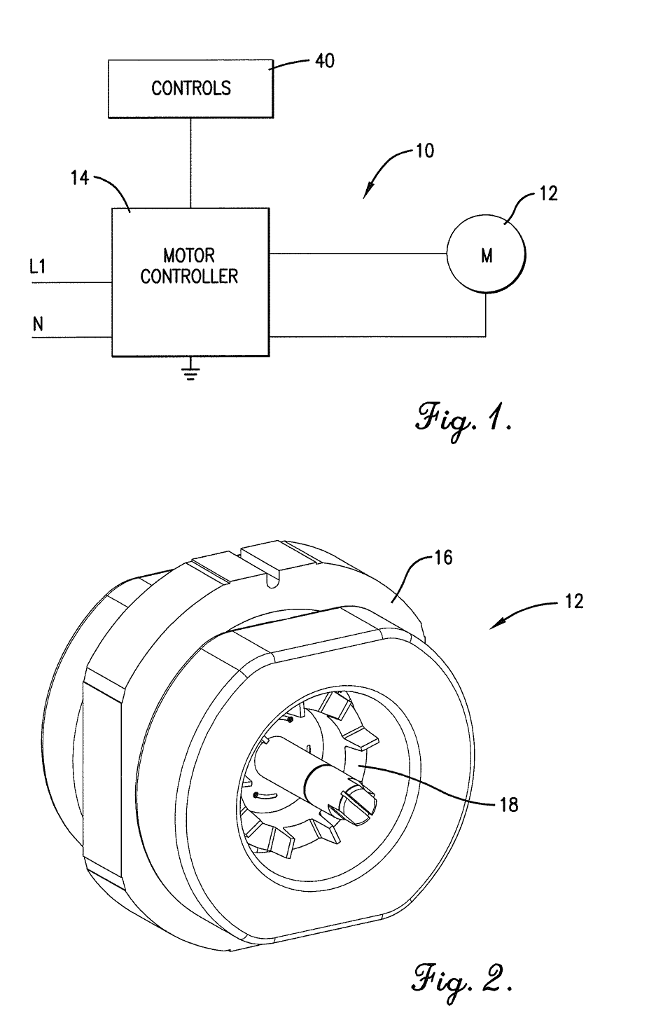

The motor 12 may operate on direct current (DC) or alternating current (AC), may be synchronous or asynchronous, may be single phase or three phase, and may have any horsepower (HP) rating. In one particular embodiment of the invention, the motor 12 is a single phase permanent split capacitor (PSC) motor rated between 30W-350W. As best illustrated in FIG. 2, the motor 12 broadly includes a stator 16 and a rotor 18 rotatably positioned within the stator.

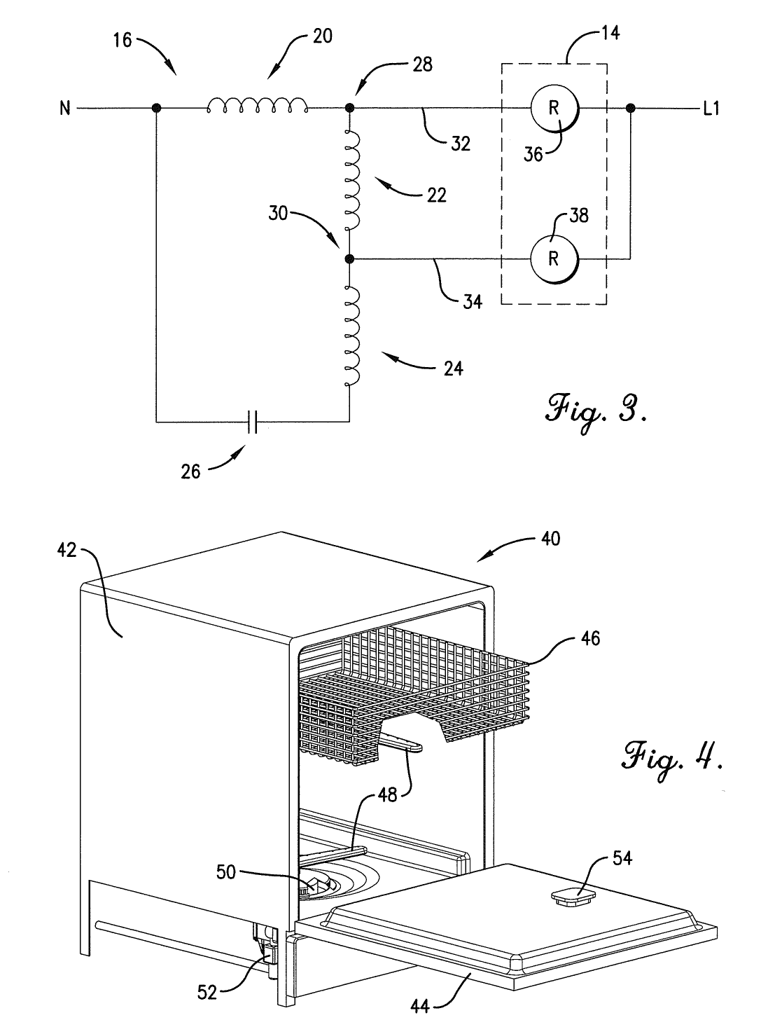

As shown in FIG. 3, the stator 16 includes a number of windings including a main winding 20, a first auxiliary winding 22, and a second auxiliary winding 24. The axes of the main winding 20 and the auxiliary windings 20, 24 are displaced 90 electrical degrees. The stator also includes a capacitor 26 connected in series with the first and second auxiliary windings 22, 24, a first tap point 28 between the main winding 20 and the first auxiliary winding 22, and a second tap point 30 between the first and second auxiliary windings 22, 24.

The main winding 20 may be formed from a length of copper or aluminum magnet wire and has a number of turns. In one embodiment, the main winding is fowled from #20 wire and has between 200 and 210 turns. The main winding 20 may consist of a single winding coil set as illustrated or multiple winding coil sets connected in series.

The first and second auxiliary windings 22, 24 are connected in series with one another and in parallel with respect to the main winding 20. The first and second auxiliary windings may be formed from lengths of copper or aluminum magnet wire, and each has a number of turns. In some embodiments of the invention, the first auxiliary winding 22 does not have the same number of turns as the second auxiliary winding 24. In some embodiments, the second auxiliary winding 24 has 25-75% as many turns as the first auxiliary winding 22. In one embodiment, the first auxiliary winding is formed from #22 wire and has between 150 and 160 turns and the second auxiliary winding is formed from #22 wire and has between 80 and 90 turns.

The first and second tap points 28, 30 may be wires, connectors, sockets, terminals or any other electrically conductive elements. The first tap point 28 is connected between the main winding 20 and the first auxiliary winding 22 and is connected to a leadwire 32. The second tap point 30 is connected between the first auxiliary winding 22 and the second auxiliary winding 24 and is connected to a leadwire 34. Leadwires 32 and 34 are in turn connected to the motor controller 14.

The capacitor 26 serves as a permanent running capacitor and is serially connected to the first and second auxiliary windings 22, 24. Together with the auxiliary windings, the capacitor 26 is in parallel to the main winding 20. In one embodiment, the capacitor has a value of approximately 23 uF.

The motor controller 14 provides power to and controls operation of the electric motor 12 and is programmed or otherwise configured to perform one or more of the functions or methods described below. As shown in FIG. 1, the motor controller 14 may receive power from a single phase AC supply voltage at 115 VAC or 230 VAL supplied by connections L1 and N, where L1 represents the “hot” side of the AC supply and N represents neutral, which is typically at earth potential. The AC supply voltage may also be 230 VAC, in which case the neutral line would be replaced with another hot supply line.

The motor controller 14 may include any combination of circuitry, hardware, firmware, and/or software. In one particular embodiment shown in FIG. 3, the motor controller 14 includes a first relay 36 or timer for providing power to the first tap point 28 and a second relay 38 or timer for providing power to the second tap point 30. The motor controller 14 may also include various other electronic components.

In alternative embodiments, the motor controller operations may be implemented with one or more computer programs stored in or on computer-readable medium residing on or accessible by the motor controller 14. Each computer program preferably comprises an ordered listing of executable instructions for implementing logical functions in the motor controller 14. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The motor controller 14 may receive commands or operating instructions from one or more controls 40 such as a keypad, switches, or buttons as are commonly found on dishwashers. The controls 40 may be one or more separate components or may be integrated in the motor controller 14.

In accordance with one important aspect of the present invention, the motor controller 14 is programmed or configured to selectively energize the first and second taps 28, 30 to provide multi-speed operation of the motor 12. Specifically, the first relay 36, timer, or another electronic component may energize the first tap point 28 so that the first and second auxiliary windings 22, 24 are in series with the capacitor 26 and the first and second auxiliary windings and the capacitor are all in parallel with the main winding 20. This provides a relatively higher motor speed. Alternatively, the second relay 38, timer, or another electronic component may energize the second tap point 30 so that only the second auxiliary winding 24 is in series with the capacitor 26 and only the second auxiliary winding and the capacitor are in parallel with the main winding 20. This provides a relatively lower motor speed.

In the higher speed mode of operation, 120 volt AC electrical power is connected to the first tap point 28 via the lead wire 32 such that both of the auxiliary winding coil sets 22 and 24 together with capacitor 26 are connected in parallel with the main winding 20. When it is desired to selectively switch the speed of the motor from its higher speed mode of operation to its relatively slower speed mode of operation, AC electrical power is removed from the first tap point 28 and is applied to the second tap point 30 via the lead wire 34. In this condition, the capacitor 26 and only the second auxiliary winding 24 are connected in parallel to the main winding 20. It will be noted that the first auxiliary winding 22 is now in series with the main winding 20 and thus effectively constitutes a part of the main winding 20.

The motor controller 14 essentially selectively energizes the auxiliary windings 22, 24 in a predetermined manner to vary the effective turn ratio between the auxiliary windings 22, 24 and the main winding 20. At higher speed modes of operation, the effective turn ratio is maximized, while at lower speeds, the first auxiliary winding 22 is effectively removed from the total auxiliary winding and placed in series with the main winding, thus reducing the effective turn ratio and the speed of the motor.

The above-described motor assembly 10 is specifically configured for use with a dishwasher 40, an example of which is shown in FIG. 4. An embodiment of the dishwasher 40 has an enclosed housing 42, cabinet, or drawer with an openable door 44; one or more racks 46 that may slide in and out of the housing for receiving dishes to be cleaned; one or more spray arms 48 for spraying water on the dishes; and a pump 50 for pumping water to the spray arms. The motor 12 described above drives the pump 50. The dishwasher may also include a water inlet valve 52 for introducing water into the dishwasher, a heating element for heating the water, one or more detergent dispensers 54, and/or other components found in conventional dishwashers.

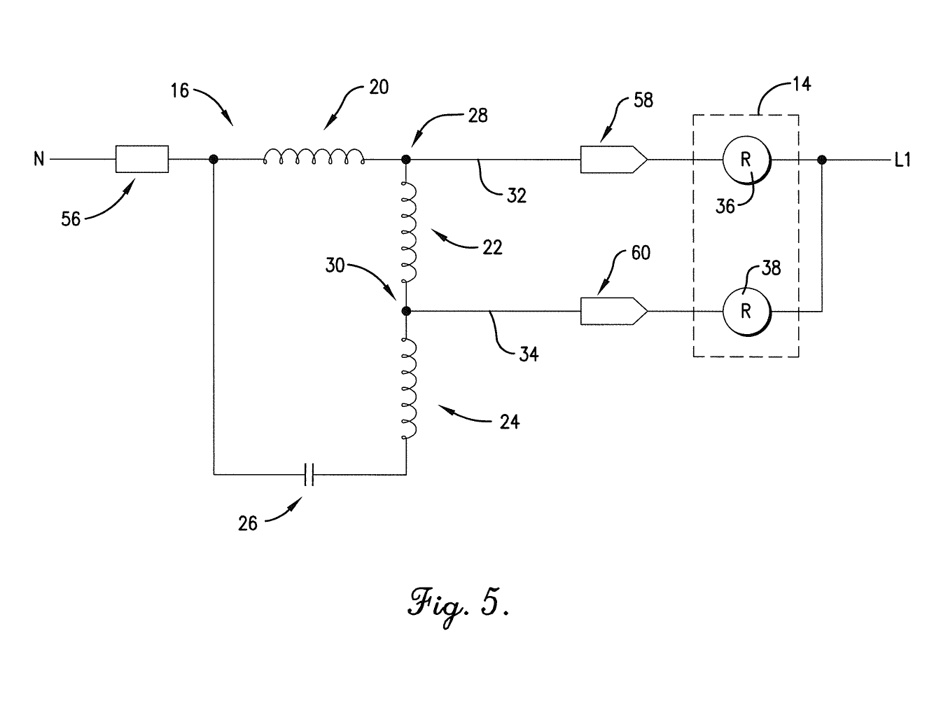

As shown in FIG. 5, the motor may also be provided with one or more thermal protectors 56, 58, 60. The thermal protector 56, 58, 60 may be simple thermal cut-out (TCO) devices or automatic thermal protectors. In some embodiments, only thermal protector 56 is needed. In other embodiments, two or even all three of the thermal protectors 56, 58, 60 are provided.

Although the invention has been described with reference to the preferred embodiment illustrated in the attached drawing figures, it is noted that equivalents may be employed and substitutions made herein without departing from the scope of the invention as recited in the claims. For example, the particular values, ratings, sizes, etc. recited herein may be changed in alternative embodiments of the invention, and such alternative embodiments are within the scope of the invention. Similarly, the principles of the present invention may be used with any dishwasher, not just the one illustrated in FIG. 4.

Having thus described the preferred embodiment of the invention, what is claimed as new and desired to be protected by Letters Patent includes the following:

1. A motor assembly for a dishwasher, the motor assembly comprising:
a motor comprising—
a stator;
a rotor rotatably positioned within the stator;
a main winding coupled with the stator;
a first auxiliary winding coupled with the stator,
a second auxiliary winding coupled with the stator;
a capacitor in series with the first and second auxiliary windings;
a first tap point between the main winding and the first auxiliary winding;
a second tap point between the first and second auxiliary windings; and
a motor controller for controlling operation of the motor and for selectively energizing the first and second taps to provide multi-speed operation of the motor, the motor controller configured to—
energize the first tap point so that the first and second auxiliary windings are in series with the capacitor and the first and second auxiliary windings and the capacitor are in parallel with the main winding to provide a relatively higher motor speed; and
energize the second tap point so that only the second auxiliary winding is in series with the capacitor and the second auxiliary winding and the capacitor are in parallel with the main winding to provide a relatively lower motor speed.

2. The motor assembly of claim 1, wherein the motor is a permanent split capacitor motor.

3. The motor assembly of claim 1, wherein the first and second auxiliary windings are each formed from a wire having a number of turns and wherein the first auxiliary winding does not have the same number of turns as the second auxiliary winding.

4. The motor assembly of claim 1, wherein the second auxiliary winding has between 25-75% of the turns of the first auxiliary winding.

5. The motor assembly of claim 1, wherein the first auxiliary winding has approximately 155 turns and the second auxiliary winding has approximately 85 turns.

6. The motor assembly of claim 1, wherein the main winding is formed from a wire having approximately 205 turns.

7. The motor assembly of claim 1, wherein the capacitor has a value of approximately 23 uF.

8. The motor assembly of claim 1, wherein the motor controller includes a first relay for energizing the first tap point for providing the relatively higher motor speed.

9. The motor assembly of claim 1, wherein the motor controller includes a second relay for energizing the second tap point for providing the relatively lower motor speed.

10. A multi-speed motor assembly for a dishwasher, the motor assembly comprising:
a permanent split capacitor motor comprising—
a stator;
a rotor rotatably positioned within the stator;
a main winding coupled with the stator;
a first auxiliary winding coupled with the stator, the first auxiliary winding formed from a wire having a number of turns;
a second auxiliary winding coupled with the stator, the second auxiliary winding formed from a wire having a number of turns less than the number of turns in the first auxiliary winding;
a capacitor in series with the first and second auxiliary windings;
a first tap point between the main winding and the first auxiliary winding;
a second tap point between the first and second auxiliary windings; and
a motor controller for controlling operation of the motor and for selectively energizing the first and second taps to provide multi-speed operation of the motor, the motor controller configured to—
energize the first tap point so that the first and second auxiliary windings are in series with the capacitor and the first and second auxiliary windings and the capacitor are in parallel with the main winding to provide a relatively higher motor speed; and
energize the second tap point so that only the second auxiliary winding is in series with the capacitor and the second auxiliary winding and the capacitor are in parallel with the main winding to provide a relatively lower motor speed.

11. The motor assembly of claim 10, wherein the ratio of the second auxiliary winding has between 25-75% of the turns of the first auxiliary winding.

12. The motor assembly of claim 10, wherein the first auxiliary winding has approximately 155 turns and the second auxiliary winding has approximately 85 turns.

13. The motor assembly of claim 10, wherein the main winding is formed from a wire having approximately 205 turns.

14. The motor assembly of claim 10, wherein the capacitor has a value of approximately 23 uF.

15. The motor assembly of claim 10, wherein the motor controller includes a first relay for energizing the first tap point for providing the relatively higher motor speed.

16. The motor assembly of claim 10, wherein the motor controller includes a second relay for energizing the second tap point for providing the relatively lower motor speed.

17. A dishwasher comprising:
a housing;
one or more racks positioned in the housing;
one or more spray arms for spraying water on the racks;
a pump for pumping water to the spray arms;
a permanent split capacitor motor for driving the pump, the motor comprising—
a stator;
a rotor rotatably positioned within the stator;
a main winding coupled with the stator;
a first auxiliary winding coupled with the stator, the first auxiliary winding formed from a wire having a number of turns;
a second auxiliary winding coupled with the stator, the second auxiliary winding formed from a wire having a number of turns less than the number of turns in the first auxiliary winding;
a capacitor in series with the first and second auxiliary windings;
a first tap point between the main winding and the first auxiliary winding;
a second tap point between the first and second auxiliary windings; and
a motor controller for controlling operation of the motor and for selectively energizing the first and second taps to provide multi-speed operation of the motor, the motor controller comprising—
a first relay to energize the first tap point so that the first and second auxiliary windings are in series with the capacitor and the first and second auxiliary windings and the capacitor are in parallel with the main winding to provide a relatively higher motor speed; and
a second relay to energize the second tap point so that only the second auxiliary winding is in series with the capacitor and the second auxiliary winding and the capacitor are in parallel with the main winding to provide a relatively lower motor speed.

18. The dishwasher of claim 17, wherein the first auxiliary winding has approximately 155 turns, the second auxiliary winding has approximately 85 turns, and the main winding has approximately 205 turns.

19. The dishwasher of claim 17, wherein the capacitor has a value of approximately 23 uF.

20. The dishwasher of claim 17, further comprising one or more thermal protection devices.
